(19) United States
(12) Patent Application Publication
(10) Pub. No.: US 2009/0150187 A1
(43) Pub. Date: Jun. 11, 2009

(54) System and method for facilitating candidate and subject participation in clinical trial studies

(75) Inventors: Peter B. Tilles, Skillman, NJ (US); Carol L. Alter, Princeton, NJ (US); H. Mikel Thomas, Leawood, KS (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: MEDAVANTE. INC, Hamilton, NJ (US)

(21) Appl. No.: 12/288,634

(22) Filed: Oct. 21, 2008

Related U.S. Application Data
(63) Continuation of application No. 10/076,738, filed on Feb. 14, 2002, now abandoned.

(51) Int. Cl. G06Q 50/00; G06F 17/30; G06Q 10/00; G06F 7/06

(52) U.S. Cl. 705/3; 707/3; 705/10; 707/E17.014; 707/E17.044

(57) ABSTRACT

The present invention discloses systems and methods for facilitating candidate and subject participation in clinical trial studies. Medical professionals participating in the study at satellite sites assist in recruitment of their pre-existing patients as subjects in the study. Clinical trial data collected from the subjects is communicated over a computer network from the satellite sites to core sites. Study coordination is performed at the core sites. The collected clinical trial data is analyzed in accordance with the study at an interested party site.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The present invention relates to computerized medical research business systems and methods; and more particularly, to systems and methods for facilitating candidate and subject participation in clinical trial studies.

High quality, rapidly executed clinical trial studies are of great importance to the pharmaceutical industry. Each year, billions of dollars are spent by pharmaceutical companies and biotechnology companies on clinical research and development to develop new pharmaceutical compounds. Clinical trial studies are a vital, expensive and time-consuming part of the research and development process. Profitability from expensively developed drugs is often dependent upon patent protection for the drug, which patent protection is of limited duration. It has been estimated that, for a given new drug, millions of dollars are lost for each day of delay in bringing the drug to market. These delays also prolong the time before new drugs or treatments are available to patients who need them. Since completion of a clinical trial study is often required before bringing a new drug to market, delays in execution and completion of such studies have a dramatic negative affect on availability of the drug as well as profitability. Moreover, delays in the studies lead to significantly greater costs associated with the study itself.

In spite of advancements in many administrative aspects of clinical trial study design and execution, rapidly obtaining the participation, including enrollment through completion, of sufficient numbers of appropriate subjects for studies has remained the most significant barrier to rapid completion of high quality, cost-effective studies. Typically, subjects are obtained through broadcast media advertisement campaigns to obtain a response from interested subject candidates. Subsequently, candidates are typically screened, interviewed or otherwise evaluated to filter out inappropriately qualified candidates and to obtain actual subjects for the study. The subjects, who are paid for their participation, then typically participate in the study by travelling periodically to clinical research sites for appropriate consultation, treatment, testing, monitoring, data collection and the like, as required for the particular study. Typically, sponsors such as pharmaceutical companies contract with organizations such as contract research organizations, or CROS, to coordinate and manage the execution of studies.

In the manner of obtaining candidate and subject participation described above, however, many factors can contribute in causing difficulty, expense and delay. Many individuals hear about the study and arrive to be screened, even though they are likely not good candidates. Of the individuals that hear about the study and have appropriate qualifications for participation, many are understandably reluctant to participate in a medical study without the involvement or recommendation of their personal physician or another trusted advisor. Indeed, the whole notion of being a “guinea pig” in a scientific study offends the sensibilities of many people. Finally, since the primary reason for individuals to participate is to be paid, higher income people are less likely to be motivated to participate.

In addition, much difficulty arises from the fact that research sites and advertising are typically limited to certain urban geographic regions with high population densities. Often, potential candidates in rural areas or areas that are otherwise not targeted by advertising may not even hear about the study. Moreover, the same urban areas are often the main source of subjects for many different studies, reducing the size of the candidate pool to draw from for any particular study. This is particularly true when related studies are performed in the same urban area, such as anti-depression drug studies, which are fairly common. In such a situation, the potential candidate pool to draw from for a given study may be significantly reduced by participation of would-be candidates for the study in another similar study. Moreover, in a situation when one study follows another similar study, subjects from the first study may be disqualified from participation in the second study by virtue of their participation in the first study.

Another problem is that people who live remote from research sites for a study may be reluctant to participate or be precluded from participation in the study due to long commuting time, inconvenience or expense. Adding numerous additional research sites to help alleviate this problem is often impractical due to the difficulty and expense associated with maintaining such research sites or in obtaining local staffing for them.

If clinical trial studies could be performed so as to improve candidate and subject participation, many important benefits would result. Overall, clinical research studies could be executed more quickly, efficiently and cost-effectively, and could yield better quality results. This would increase the rapidity with which new drugs could be safely brought to market, increasing profitability from sales of the drug as well as making important new drugs available to the public.

Methods and systems have been proposed for increasing efficiency in handling and distributing clinical trial data once obtained. For example, U.S. Pat. No. 5,666,490 issued on Sep. 9, 1997 to Gillings et al. discusses a method for managing clinical trial data over a computer network. Published Patent Cooperation Treaty (P.C.T.) international application, publication no. WO 01/93160 filed on May 25, 2001 discusses a system in which participants in clinical trials can store, access and exchange data over a computer network such as the Internet. Published P.C.T. international application publication no. WO 01/69490 discusses a networked computerized system for use in conducting clinical trials, in which data may be stored in a database and queried by users. Published P.C.T. international application publication no. WO 01/55942 discusses an on-line forum allowing exchange of information between various parties involved in clinical studies, including sponsors, investigators and potential subjects. Published P.C.T. international application publication no. WO 01/93178 discusses a computerized system for managing the planning, conduct, and analysis of clinical trials. Finally, published P.C.T. international application publication no. WO 01/82173 discusses a method for secure, on-line recruitment of candidates for clinical trials.

The foregoing patent and applications, which are generally indicative of present activity in the field, all attempt in some way to increase the efficiency of processing and distributing data from clinical trial studies, generally by the use of computer systems. None, however, alleviates the fundamental problem of the unsatisfactory existing process for obtaining candidate and subject participation in clinical trial studies. Thus, the above described problems in existing clinical trial studies persist.

Therefore, there is a need in the art for systems and methods for facilitating candidate and subject participation in clinical trial studies.

### SUMMARY OF THE INVENTION

The present invention provides systems and methods for obtaining candidate and subject participation in clinical trial studies. In one embodiment, the invention provides a system for facilitating candidate and subject participation in a clinical trial study. The system includes one or more interested party sites at which collected clinical trial data is analyzed in accordance with the study, each of the interested party sites having one or more interested party site computers, and the collected clinical trial data being communicated to the interested party site computers over a network. The system further includes a plurality of core sites at which coordination of the clinical trial study is performed, each of the core sites having one or more core site computers. The system further includes a plurality of satellite sites at which one or more medical professionals participating in the study assist in recruitment of one or more patients of the medical professionals as subjects in the study from whom a first set of clinical trial data of the collected clinical trial data is collected, each of the satellite sites having one or more satellite site computers connected through the network to at least one of the core site computers. The first set of clinical trial data is communicated from each of the satellite sites by one or more of the satellite site computers over the network to one or more of the core site computers.

In another embodiment, the invention provides a method for facilitating candidate and subject participation in a clinical trial study. The method includes a plurality of medical professionals at a plurality of satellite sites assisting in recruitment of one or more patients of the medical professionals as subjects in the study. The method further includes one or more of the subjects in the study participating from the satellite sites, including collecting a first set of clinical trial data from the subjects and communicating the first set of clinical trial data over a network from one or more satellite site computers at the satellite sites to one or more core site computers at a plurality of core sites. The method further includes performing clinical trial study coordination at the core sites. The method further includes analyzing the first set of clinical trial in accordance with the study at one or more interested party sites, the first set of clinical trial data being communicated to one or more interested party site computers at the one or more interested party sites over the network.

In another embodiment, the invention provides a computer usable medium storing program code which, when executed on a computerized device, causes the computerized device to execute a method for facilitating candidate and subject participation in a clinical trial study. The method includes a plurality of medical professionals at a plurality of satellite sites assisting in recruitment of one or more patients of the medical professionals as subjects in the study. The method further includes one or more of the subjects in the study participating from the satellite sites, including collecting a first set of clinical trial data from the subjects and communicating the first set of clinical trial data over a network from one or more satellite site computers at the satellite sites to one or more core site computers at a plurality of core sites. The method further includes performing clinical trial study coordination at the core sites. The method further includes analyzing the first set of clinical trial in accordance with the study at one or more interested party sites, the first set of clinical trial data being communicated to one or more interested party site computers at the one or more interested party sites over the network.

Enhancing obtaining candidate and subject participation in clinical research studies by, for example, expanding the geographical region, and hence the population, from which candidates may practically be drawn leads to a number of advantages. Enrollment of subjects is made easier and more rapid, leading to more rapidly completed studies and associated increased drug sales profitability. The greater potential candidate pool also allows for a greater degree of selectivity in selecting, or screening, candidates for participation in studies, and hence better qualified subjects and higher quality studies. Also, having better qualified candidates also results in a higher ratio of subjects that actually complete the study, further increasing study completion rapidity and reducing costs associated with patient drop-outs. Additionally, study quality is enhanced by the increase in diversity of the participating subjects due to the expanded geographic region, which leads to greater statistical integrity for the study and more reliable global applicability of the study results.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram of a system including core sites, satellite sites, and an interested party site utilized in conducting a clinical trial study according to one embodiment of the invention;

FIG. 2 is a block diagram of a networked distributed computer system including core site computers, satellite site computers, interested party site computers, a clinical trial database and ancillary databases utilized in conducting a clinical trial study according to one embodiment of the invention;

FIG. 3 depicts a networked distributed computer system utilized in conducting a clinical trial study according to one embodiment of the invention, including five core sites, a set of satellite sites associated with each core site, an interested party site, a clinical trial database and an ancillary database;

FIG. 4 is a simplified depiction of a graphical user interface displayed on a core site computer monitor and an associated graphical user interface displayed on an associated satellite site computer monitor according to one embodiment of the invention;

FIG. 5 is a simplified depiction of one of the graphical user interfaces depicted in FIG. 4 and an associated set of technical equipment according to one embodiment of the invention;

FIG. 6 is a flow diagram depicting a method for facilitating candidate and subject participation in a clinical trial study according to one embodiment of the invention;

FIG. 7 is a flow diagram of one embodiment of the method for facilitating candidate and subject participation in a clinical trial study as depicted in FIG. 6; and

FIG. 8 is a chart depicting improved subject recruitment according to one embodiment of the invention.

### DETAILED DESCRIPTION OF THE PREFERRED EMBODIMENTS

In the following description of the preferred embodiment, reference is made to the accompanying drawings that form a part hereof, and in which is shown by way of illustration a specific embodiment in which the invention may be practiced. It is to be understood that other embodiments may be utilized and structural changes may be made without departing from the scope of the present invention.

The present invention generally provides systems and methods for facilitating candidate and subject participation in clinical trial studies. Medical professionals participating in the study at satellite sites assist in recruitment of their patients as subjects in the study. Clinical trial data collected from the subjects is communicated over a computer network from the satellite sites to the core sites. Clinical trial study coordination is performed at the core sites. The collected clinical trial data is analyzed at one or more interested party sites in accordance with the study.

The phrase, “interested party” as used herein means any party or entity, such as, for example, a sponsor of contract research organization, having an interest in a particular clinical trial study, such as having responsibility for the performance of the clinical trial study or having a need for the completion of the clinical trial study or the results of the clinical trial study.

The phrase “clinical trial study” as used herein is intended to broadly include many types of clinical or medical studies of subjects, generally in connection with obtaining data regarding the subjects' response to treatment such as, for example, the taking of medication. The term “medical professional” as used herein is intended to broadly include a wide range of individuals employed in medical or health care related fields, including, for example, physicians. The term “patient” (of a medical professional) as used herein is intended to broadly include any individual who has received or is receiving any medical or health care related treatment or advice by, through, or in connection with the associated medical professional. The term “Pre-existing patient” as used herein means an individual who had been a patient of a medical professional prior to any recruitment or assistance in recruitment by the medical professional of the individual for a particular clinical trial study.

The term “candidates” is intended to broadly include individuals who are made aware of a clinical trial study so that they can consider participating as a subject, can attempt to participate as a subject, or can in fact participate as a subject in the study. The phrases “recruitment of subjects”, “recruitment . . . as subjects”, and the like as used herein refer broadly to conduct intended to lead to obtaining candidates or subjects for a study. For example, “recruitment of subjects” includes making an individual who may potentially be suitable for participation in a clinical trial study aware of the clinical trial study, recommending that the individual consider participating or attempting to participate in the study, or actually enrolling the individual as a subject in the study. The term “investigator” as used herein refers to any individual or group with substantial responsibility in the performance of a clinical trial study, including, for example, the coordination or management of a clinical trial study, or analysis of clinical trial study data, and including, for example, medical professionals involved with the study.

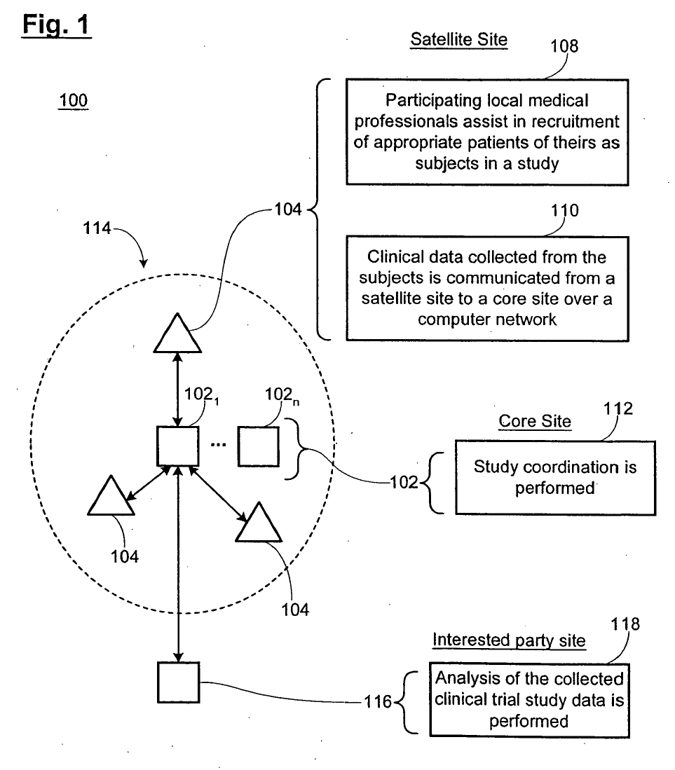

FIG. 1 is a block diagram of a system 100 including core sites 102₁₋ₙ, three satellite sites 104 associated with the core site 102₁, and an interested party site 116 utilized in conducting a clinical trial study according to one embodiment of the invention. A particular clinical trial study according to the invention includes one or more core sites and one or more satellite sites, each satellite site being associated with one or more core sites. Any number of core sites can be used in accordance with the invention. Additionally, any number of satellite sites can be associated with each core site. For example, three satellite sites 104 are shown associated with the core site 102₁. Other sets of core sites (not shown) are associated with each of the other core sites 102₂₋ₙ. Furthermore, while one interested party site 116 is shown, more than one can be utilized in accordance with some embodiments of the invention.

As shown by box 1 12, clinical trial study coordination is performed at the core sites 102₁₋ₙ. In some embodiments of the invention, the core sites 102₁₋ₙ serve as centers for coordination and management of the clinical trial study, which can include monitoring of study activities conducted at the satellite sites 104. In some embodiments, some subjects attend the core sites 102₁₋ₙ to participate in the study.

As shown by box 118, analysis of the collected clinical trial study data is performed at the interested party site 116. For example, box 118 can represent a study sponsor or contract research organization associated with the study performing analysis of all study data, including the collected clinical trial study data, to generate study results which can comprise statistical data regarding subjects' responses to medication or treatment. In some embodiments of the invention, the collected data is communicated from the core sites 102₁₋ₙ to the interested party site 116.

While the following comments focus on activities occurring at the core site 102₁ and the satellite sites 104 associated therewith, it is to be understood that similar activities occur at the other core sites sites 102₂₋ₙ and their associated satellite sites (not shown).

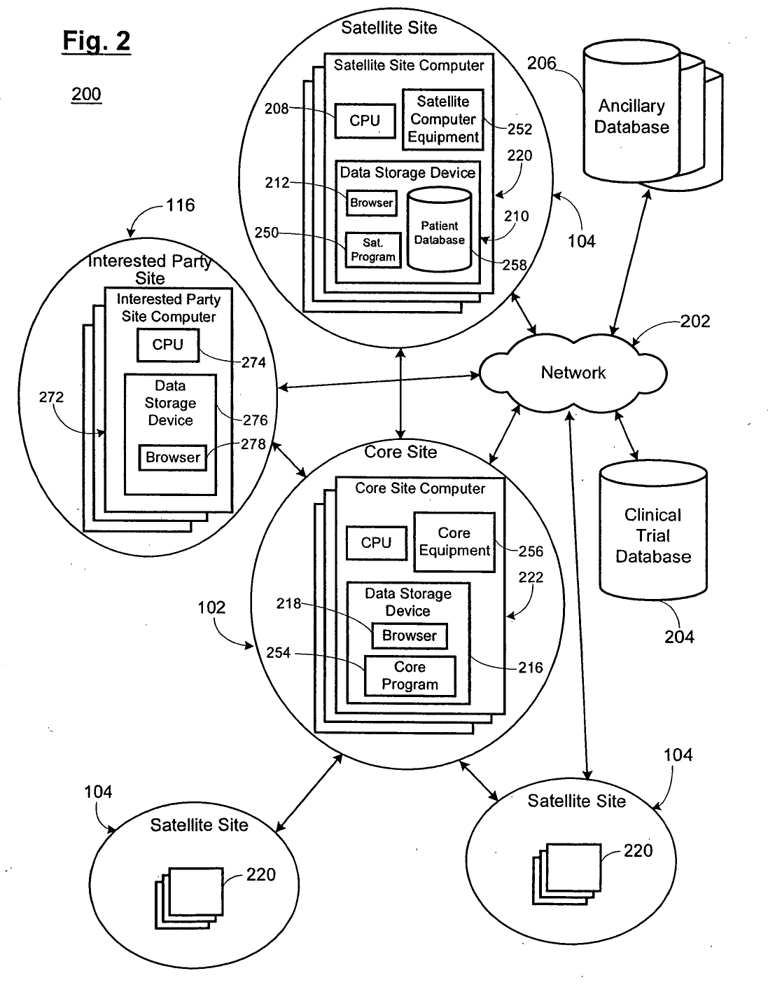

As shown in box 108, at the satellite sites 104, participating local medical professionals, such as physicians, assist in recruitment of appropriate patients of theirs as subjects in the study. As shown in box 110, clinical data collected from subjects is communicated from the satellite sites 104 to the core site 102₁ over a computer network, one embodiment of which computer network is depicted in and discussed with reference to FIG. 2.

The system 100 depicted in FIG. 1 has several advantages over existing clinical trial studies. Existing systems typically utilize one or more dedicated research sites to conduct a study, at which research sites activities are performed which typically include treatment or advising of subjects, data collection, data analysis, and study management and coordination. An advertising campaign of some sort is typically conducted to obtain subjects for the study, which advertising campaign is typically concentrated or directed to cover the regions surrounding the research sites. These regions are targeted largely because subjects typically must travel to the research sites to participate, and candidates will likely be reluctant or not practically able to travel too long a distance to do so.

Unlike existing systems, however, the system 100 depicted in FIG. 1, in part through the use of satellite sites, facilitates participation of a much larger pool of potential candidates and subjects drawn from a much larger region. Region 114, depicted by a broken circle, is intended to demonstrate a region near enough to the core site 102₁ or to one of the satellite sites 104 so that candidate and subject participation is practical. Without the satellite sites 104, the region from which candidate and subject participation would be practical, and hence the pool of S potential candidates and subjects, would naturally also be much smaller. Yet, as described in greater detail below, the satellite sites 104 are not full scale research sites at which data analysis, study management and coordination, or other activities associated with a full scale research site may be performed. In addition, the use of satellite sites can sometimes reduce the number of required core sites for a study, which can significantly reduce costs.

Rather, a satellite site 104 may be, for example, a participating local physician's offices. In some embodiments of the invention, the physician's office is equipped to enable or facilitate its use as a satellite site 104, as described in detail below. Because the physician is typically trusted by his patients, the assistance of the physician in recruiting appropriate patients of his or hers as subjects in invaluable. Thus, in the embodiment depicted in FIG. 1, candidate and subject participation is facilitated greatly over that of traditional systems both in that the region in which candidates and subjects may practically be drawn is greatly expanded, and in that recruitment of candidates and subjects is dramatically enhanced through the participation of the local physicians at the satellite sites. Physicians can benefit from participation, among other reasons, from the public exposure from participating, as well as the opportunity to bring cutting-edge treatments to their patients. In some embodiments, where appropriate, physicians as well as subjects are compensated for their participation in the study.

FIG. 2 depicts a block diagram of a networked distributed computer system 200 utilized in conducting a clinical trial study according to one embodiment of the invention. The computer system 200 includes one or more core site computers 222 located at the core site 102₁, three sets of one or more satellite site computers 220, each set of the satellite site computers 220 being located at a different one of the satellite sites 104, one or more interested party site computers 272 located at the interested party site 116, a clinical trial database 204, and one or more ancillary databases 206. The network 202, connecting the various computers 220, 222, 272 and the databases 204, 206, is intended to broadly include any of various types of computer networks or an array of networks which can include one or more local area networks, one or more wide area networks, and the Internet 202. In addition, the network 202 can be a wireless network, and communication between computers can be through wireless connections, such as, for example, wireless Internet connections. In one embodiment of the invention, communication is not facilitated between satellite site computers, in order to help maintain study integrity or for other reasons.

Each of the satellite site computers 220, the core site computer 222, and the interested party site computer 272 comprises one or more central processing units (CPUs) 208, 214, 274 and one or more data storage devices 210, 216, 276 comprising one or more browser programs 212, 218, 278 to allow access to and communication through the network 202. For example, in embodiments in which the network 202 comprises the Internet, the browser programs 212, 218, 278 can be Microsoft's Internet Explorer or another Internet browser. The data storage devices 210, 216, 276 may comprise various amounts of RAM for storing computer programs and other data. In addition, the core site computer 222, satellite site computers 220, and interested party site computer 116 may include other components typically found in computers, including one or more output devices such as monitors, other fixed or removable data storage devices such as hard disks, floppy disk drives and CD-ROM drives, and one or more input devices, such as mouse pointing devices, styluses, cameras, and keyboards. In addition, various other computer and computer related components may be utilized, in part, to enhance communication between the core site computer 222 and the satellite site computers 220.

Generally, the core site computer 222, the satellite site computers 220, and the interested party site computer 272 operate under and execute computer programs under the control of an operating system, such as Windows, Macintosh, UNIX, etc. Further, generally, the computer programs of the present invention are tangibly embodied in a computer-readable medium, e.g., one or more data storage devices attached to a computer. Under the control of an operating system, computer programs may be loaded from data storage devices into computer RAM for subsequent execution by the CPU. The computer programs comprise instructions which, when read and executed by the computer, cause the computer to perform the steps necessary to execute elements of the present invention.

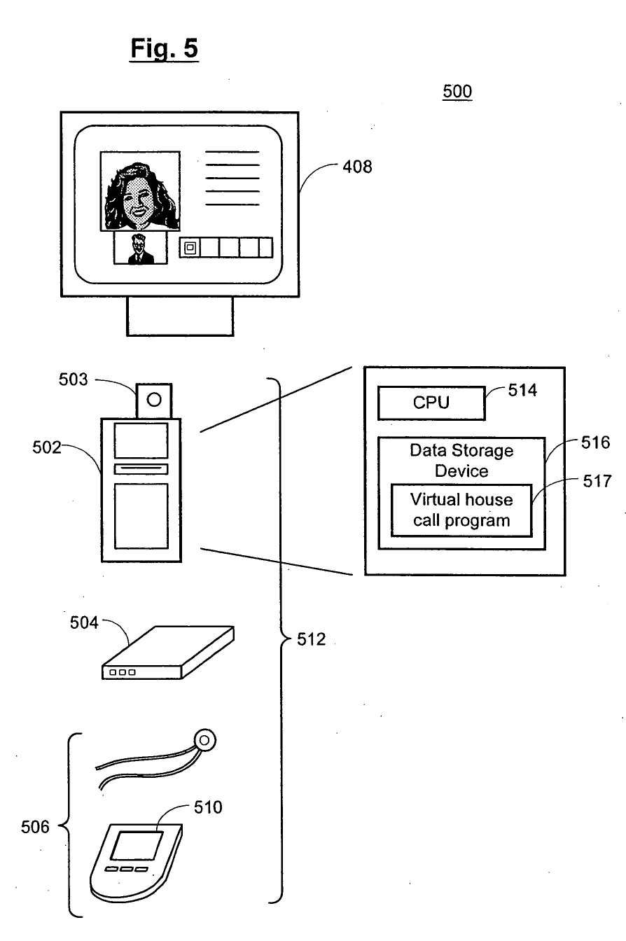

The satellite site computers 220 comprise satellite computer equipment 252, and the data storage devices 210 of the satellite site computers comprise a satellite program 250. The satellite site computers 220 are programmed and equipped to allow medical professional and subject participation from the satellite sites 104, and communication of clinical trial data obtained from the subjects to the core site computers 222. One embodiment of the satellite computer equipment 252 and satellite program 250 are described in detail with reference to FIG. 5.

As depicted, the data storage device 210 of the satellite site computer 220 comprises a patient database 258. The patient database 258 is depicted as residing in the sat site computer 222, but, in other embodiments, the patient database 258 may reside elsewhere. A participating medical professional, such as a physician, at the satellite site 104 utilizes the patient database 258 to select or identify patients of his or hers who seem likely to be appropriately qualified to participate as subjects in the study.

Medical professionals generally maintain databases of patient information which can be of great use, according to the present invention, in allowing participating medical professionals at the satellite sites 104 to assist in recruitment of appropriate ones of their patients as subjects at the satellite sites. In one embodiment, the patient database 258 is the sort of general database maintained by most physician practices, containing various information about patients medical histories, medical conditions, prescription histories, disease states and the like. In other embodiments the patient database 258 is specially maintained to be utilized in selecting and identifying appropriate patients to participate as subjects in studies. In some embodiments, the patient database 258 can simply be reviewed to identify the appropriate patients, or, in other embodiments, it can be utilized in a more sophisticated manner, such as being mined using a data mining program such as those described below.

The core site computer 222 comprises core computer equipment 256, and the data storage device 216 of the core site computer 222 comprises core program 254. The core computer equipment 256 and the core program include all the equipment and programming necessary to support core site functions, including communication and interfacing with the satellite site computers 104 as well as study coordination. Collected clinical trial study data is ultimately sent over the network to the interested party site computer 116, where it is analyzed in accordance with the study. For example, in various embodiments of the invention, collected clinical trial study data can be sent from the satellite site computers 104 simultaneously to both the core site computer 102₁ and the interested party computer 116, or the clinical trial data can be sent from the satellite site computers 104 to the core site computer 102₁ and from the core site computer 102₁ to the interested party computer 116. In addition, in some embodiments of the invention, collected clinical trial study data can be sent from the satellite site computers 104 to some intermediary source, and sent from the intermediary source to the core site computer 102₁.

In some embodiments, clinical trial data is collected from subjects at the satellite sites 104, input into the satellite site computers 104, and communicated over the network 202 to the core site computer 222. Clinical trial data may be nonvolatilely stored in the data storage devices 210, 216 of the core site computers 222 or the satellite site computers 220, in the clinical trial database 204, or any combination thereof. For example, clinical trial data may be input into the satellite site computer and immediately communicated over the Internet 202 to the core site computer 222 for nonvolatile storage therein, or may be communicated to the clinical trial database 204 and accessed or manipulated remotely from the core site computer 222. Although only one clinical trial database 204 is depicted, in other embodiments, multiple clinical trial databases in one or more locations are utilized. Information from the clinical trial database 204 can be used and analyzed in various ways to complete the objectives of the study, and, in some embodiments, for other purposes as well, as explained further below.

The databases 204, 206, 258 may comprise, for example, any of numerous types of databases, including, for example, an Oracle® relational database system, commercially available from Oracle® Corporation, a commercially available DB2 database, a Lotus® Domino™ server computer database, a Sybase® database, available from Sybase® Corporation, Microsoft® Structured Query Language (SQL) servers, and various Open DataBase Compliant (ODBC) databases.

In addition to the clinical trial database, one or more ancillary databases 206 can be utilized to store data including statistical data related in various ways to one or numerous clinical trial studies. For example, the ancillary databases may be utilized to store and effectively warehouse data relating to the practices of participating physicians, available medical history data including disease state data regarding patients of particular physicians, data regarding percentages of participating subjects recruited by a particular physician who complete the study as opposed to dropping out prior to completion, data relating to core sites and satellite sites utilized for various studies, etc.

Data stored in the ancillary databases 206 or the clinical database 204 can be utilized for a variety of uses. For some uses the data is mined using data mining software. Examples of the data mining software that can be utilized by some embodiments of invention include the INTELLIGENT MINER software, including the IBM DB2 INTELLIGENT MINER FOR DATA, available from International Business Machines, the MINESET™ software available from SGI™, and various data mining software available from SPSS®.

Some examples of uses of information from the databases 204, 206 include, for example, using information from past clinical trial studies in more effectively planning future studies, such as by querying a database to determine physicians with high percentages of recruited subjects who complete studies, physicians whose patients have medical histories which suggest that they may be appropriate subjects for a particular study, and which core or satellite sites have been most effective in producing clinical trial data. In addition, in some embodiments, where appropriate, the information stored in the databases 204, 206 is used for purposes beyond clinical trial study related purposes, including, for example, targeted advertising directed to physicians and patients about which information is stored in the databases 204, 206, or the information may be sold for such use. One skilled in the art will recognize other uses of the information stored in the databases 204, 206 in clinical trial study planning and management and other contexts.

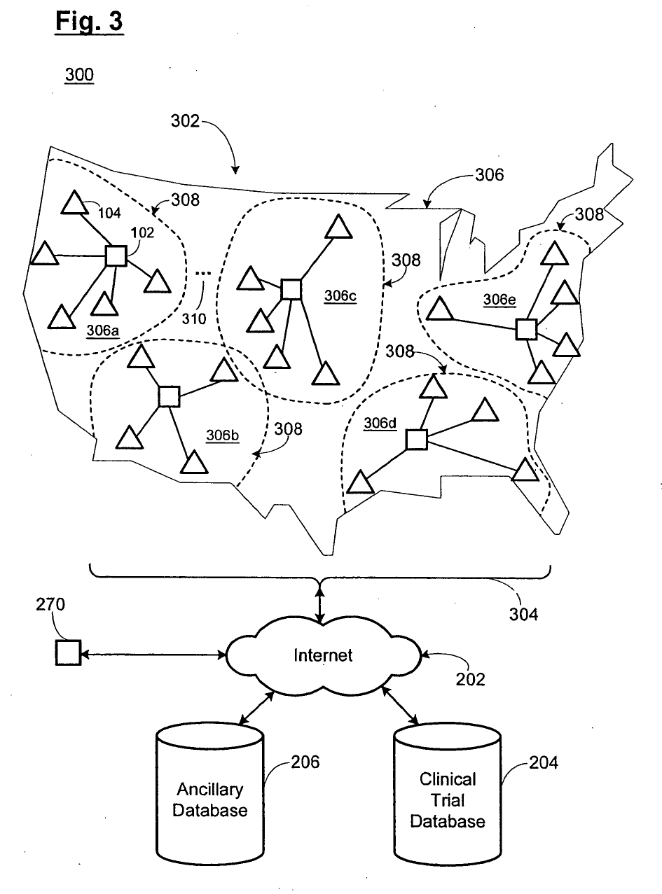

FIG. 3 depicts a networked distributed computer system 302 utilized in conducting a clinical trial study according to one embodiment of the invention, including five core sites 102, a set of satellite sites 104 associated with each of the core sites 102, an interested party site 270, the clinical trial database 204, and the ancillary databases 206. As depicted in FIG. 3, the Internet 202 is utilized in connecting and communication between the computers 102, 104, 270 and databases 204, 206. In other embodiments of the invention, however, other network architectures which do not include the Internet may be utilized.

As depicted in FIG. 3, a computer system 302 is utilized which comprises five computer subsystems 306ₐ₋ₑ, each of which of the computer subsystem subsystems 306ₐ₋ₑ is similar to the computer system 100 depicted in and described with reference to FIG. 1. Although five computer subsystems 306ₐ₋ₑ are depicted, this number is just one example, and, as indicated by ellipsis 310, it is to be understood that any number of such computer subsystems can be utilized in different embodiments of the invention. While not intended to be drawn to scale, in the embodiment depicted, the computer subsystems 306ₐ₋ₑ are located in different regions of the United States 306, and regions 308, which can overlap, together allow practical participation of subjects in the study from a large portion of the United States.

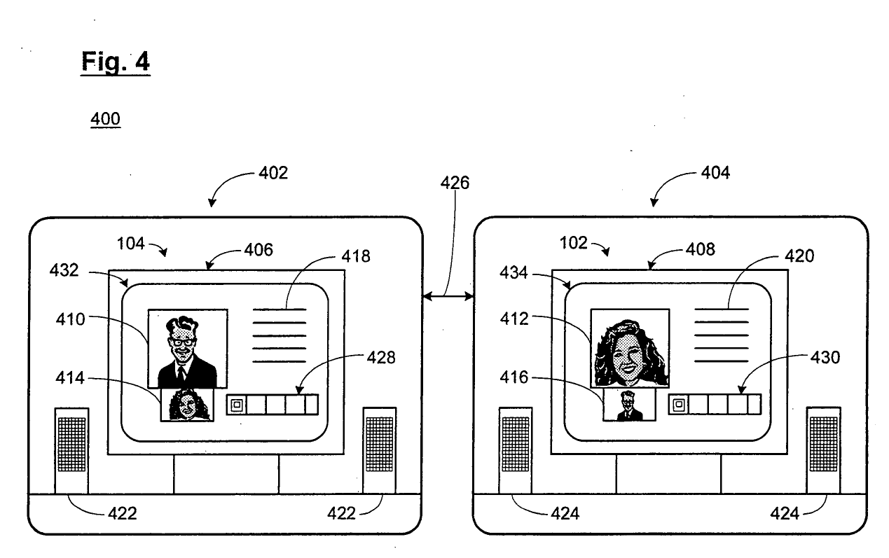

In some embodiments of the invention, study related activities that occur at the satellite sites 104 include initial screening of candidates by participating medical professionals, scheduling and dispensing of medication or other treatment by the medical professionals to subjects, and evaluating of subjects by the medical professionals. In some embodiments, study coordination activities occurring at the core sites 102 include completion and maintenance of paper or electronic clinical research forms, and interfacing over the Internet 202 between investigators, medical professionals or other individuals associated with the clinical trial study from the core site computers 222 at the core sites 102 with subjects participating from the satellite sites 104 and using satellite computers 220, as described in greater detail below with reference to FIGS. 4-5. In the embodiment depicted, clinical trial data from all of the computer subsystems 306ₐ₋ₑ is stored at least in the clinical trial database 204, and other data relating generally to the study is stored at least in the ancillary database 206.

FIG. 4 is a simplified depiction of a graphical user interface 434 displayed on a core site computer monitor 408 at a core site and an associated a graphical user interface 432 displayed on an associated satellite site computer monitor 406 at an associated satellite site according to one embodiment of the invention. In some embodiments of the invention, real time or almost real time video or audio, on line chat, or other communications technologies are utilized to enhance communications between core sites and associated satellite sites. Such enhanced communications can be quite useful in providing subjects participating from satellite sites with the benefit of remote resources and experiences.

Further, in some embodiments of the invention, specially designed software, as well as hardware or other equipment, is utilized in providing enhanced communications relating to the clinical trial study between core site computers and associated satellite site computers. FIG. 4 is intended to help illustrate an embodiment in which real time or almost real time video is utilized in communications between the core site computer 222 at a core site, and in which specialized software is utilized to further enhance or simplify the experience for users. FIG. 4 includes a simplified snapshot 402 of the satellite site computer area and a simplified snapshot 404 of the core site computer area. Double-headed arrow 426 is intended to indicate that the core site computer 222 as well as the satellite site computer 220 are both connected to the Internet 202 and communicate with each other utilizing high speed Internet access connections, such as, for example, by cable modems or DSL.

As depicted in FIG. 4, the graphical user interfaces 432, 434 are custom provided utilizing specialized software, which can be programmed by one skilled in the art based on the description provided herein, to suit anticipated needs of a participating subject using the satellite site computer 220 at a satellite site 104 communicating with, for example, a medical professional or an investigator using the core site computer 222 at a core site 102. Specifically, FIG. 4 depicts an example of a real time or almost real time two way video and audio conference between a subject and a medical professional. At the satellite site computer monitor 406, a window 410 shows an image of the medical professional engaged in the conference. Small window 414 shows an image of the subject who is sitting in front of the monitor 406. Similarly, at the core site computer monitor 408, a window 412 shows an image of the subject engaged in the conference. Small window 416 shows an image of the medical professional who is sitting in front of the monitor 408. Sets 422, 424 of speakers at each of the computers 222, 220 are used in providing real time or almost real time audio conferencing capability.

Each of the graphical user interfaces 432, 434 includes text areas 418, 420 with lines of text, which text is shown in simplified form as straight lines. The text areas 418, 420, as depicted, are used for online chatting between the subject and the medical professional, but may be used for other purposes in various embodiments, such as, for example to show medical or health care information, or a passage from on online article.

The graphical user interfaces 432, 434 also include multiple button tool bars 428, 430. The special software programs can be executed to facilitate use of buttons on the tool bars 428, 430 to aid in the conference, which may be a “virtual house call” in which the subject communicates from the satellite site computer 220 clinical trial data or other medical data to the medical professional and the core site computer 222, and the medical professional interacts with the subject to provide guidance, feedback, or medical advice. For example, the buttons may each be used to represent a particular medical monitoring instrument, and pressing the button may cause a new window to open displaying detailed information about current or past readings from the instrument, or the new window may show the instrument itself showing the readings. In some embodiments, the screens of the monitors 406, 408 are touch sensitive, and a pen-like device, or stylus, may be used to select buttons or otherwise interact with the graphical user interfaces 432, 434. In other embodiments, a pointing device such as a “mouse”, or simply a keyboard may be used. In some embodiments, users participate in virtual house calls even though they have a minimum of computer proficiency.

FIG. 5 is a simplified depiction of one of the graphical user interface 404 depicted in FIG. 4 and an associated set 512 of technical equipment that can be utilized in or as part of some embodiments of the satellite site computer 220, and in implementing the virtual house call as discussed with reference to FIG. 4 above. The equipment and programming described with reference to FIG. 5 represents one embodiment of the satellite computer 220, including the satellite computer equipment 252 and the satellite program 250.

As shown, the set 512 includes a control station computer 502, a camera 503 for use with a computer, or “Webcam”, a cable modem 504, and one or more electronic medical monitoring devices 506. The camera 503 is used in providing video conferencing functionality. The cable modem 504 provides high speed Internet access, such as, for example, Internet access at a download speed of 100,000 bits per second or higher.

The one or more electronic medical monitoring devices 506 may include, for example, a stethoscope, a pulse Oximetry monitor, a thermometer, a weight scale, a blood pressure monitor, and other devices to provide clinical trial data and other medical or health care data from subjects or other participants. In the embodiment depicted, the electronic medical monitoring devices is connected to the control station computer 502 and information from them can be displayed or interacted with using the graphical user interfaces 432, 434 (as shown in FIG. 4). In some embodiments, the set 512 of equipment is utilized in acquiring clinical trial data from subjects at satellite sites 104, in some cases with assistance from medical professionals, and in communicating the data to core sites 102. The set of equipment may also include other electronic devices, such as personal digital assistants (PDAs) which can connect to and operate in cooperation with a computer, and which may aid a medical professional participating in a study or a subject in activities they perform in connection with the study.

The control station computer 502 comprises a CPU 514 and a data storage device 516. The control station computer 502 is utilized in some embodiments of the invention in which the core site computer 222 or satellite site computer 220, and various other equipment for use with the computer which may include providing Internet access, is specially provided for the clinical trial study. In some embodiments, the control station computer 502 and associated peripheral equipment can itself be one of the core site computers 222 or one of the satellite site computers 220, or, in other embodiments, it can be part thereof.

The data storage device 516 comprises a virtual house call program 517. The virtual house call program 517 is intended to broadly represent all programming necessary to carry out computer functions appropriate in carrying out clinical trial study related activities, such as, in some embodiments, virtual house calls, as described above with reference to FIG. 4. The exact configuration of the satellite site computers 220, and, if utilized, the control station computer 502 will vary depending on the exact requirements of the particular clinical trial study for which they are being used. Similarly, the virtual house call program 517, or other software used to provide clinical trial study related uses, will also vary. In some embodiments, the electronic virtual call program 517 helps allow users to participate in such conferences with a minimum of computer proficiency or experience with using the virtual house call program 517.

While FIG. 5 describes satellite site computer equipment and programming, it is to be understood that the core site computers 222 include, among other things, all the necessary hardware and programming to support interface with the satellite site computers 220.

It should be understood that, in different embodiments of the invention, the core site computers 222 and satellite site computers 220 can be computers that were already present prior to any clinical trial studies having been participated in from the associated sites, which computers may have been used for general office purposes, for example. In some embodiments, such computers can be upgraded, additionally equipped, provided with additional software, or provided with Internet access or faster Internet access, to allow them to be used in a particular clinical trial study in accordance with the invention. In other embodiments, the computers 222, 220, software, equipment, and Internet access can be designed or provided specially or exclusively for use in the clinical trial study.

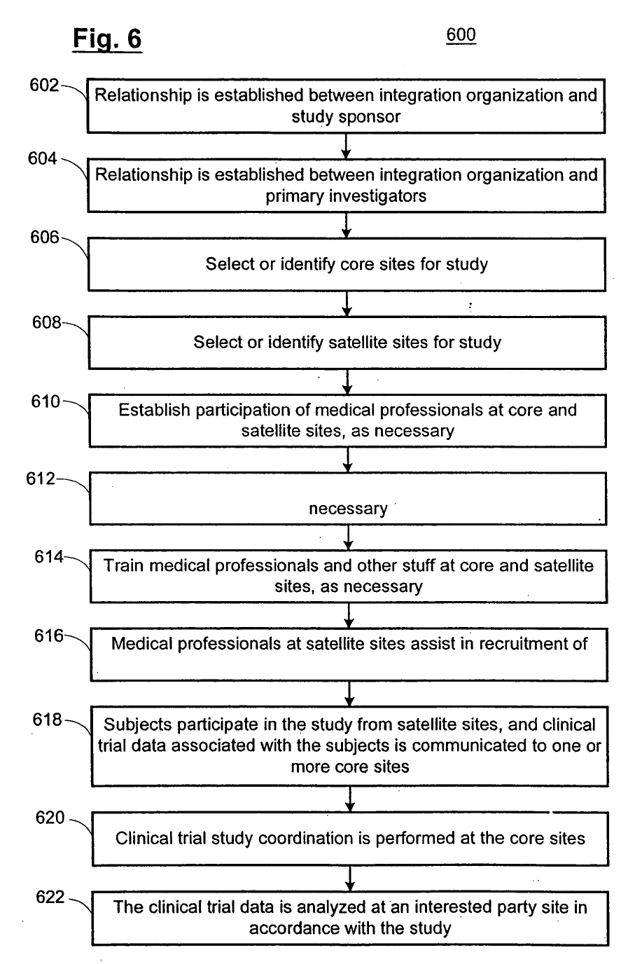

FIG. 6 is a flow diagram depicting a method 600 for facilitating candidate and subject participation in a clinical trial study according to one embodiment of the invention. FIG. 6 assumes that various parties having an interest in the performance of a clinical trial study come together to perform a clinical trial study in accordance with the invention. In the embodiment depicted in FIG. 6, one of these entities, called an integration organization, helps integrate the parties to establish a cooperative effort. It is to be understood that the parties and their roles can vary in other embodiments of the invention.

At step 602, a relationship is established between the integration organization and a study sponsor, which study sponsor may be, for example, a pharmaceutical company or biotechnology company. At step 604, a relationship is established between the integration organization and investigators for the study. In some embodiments, these relationships are established in part to enhance cooperation between the various parties.

At step 606, core sites for the study are selected or identified. In some embodiments, step 606 includes selecting core sites based at least in part on relationships existing prior to the study and its planning between parties involved in the study, such as the sponsor or CRO. For example, in some embodiments, the core sites or a group of possible core sites may be designated by the sponsor or CRO involved in the study. In some embodiments, core sites are selected at least in part based a comparison and matching of the disease state involved in the study with the disease states of expertise or specialty of the core sites or medical professionals therein.

At step 608, satellite sites 104 for the study are selected or identified. In some embodiments, individuals such as medical professionals at the core sites may designate or assist in the selection of satellite sites 104 based on relationships existing between the core sites 102 and the satellite sites 104 prior to the study or its planning. In some embodiments, publicly accessible or other databases, such as, for example, the Integrated Medical Services database, are utilized in satellite site 104 selection. For example, the Integrated Medical Services database and other databases contain compiled information regarding physician practices, physician prescription histories, and disease states of expertise of physicians and particular medical groups. Characteristics of the study, such as the disease state or states involved in the study, can be compared with such information to obtain matching, preferred or appropriate satellite sites 104 or particular physicians at satellite sites 104.

In one embodiment of the invention, satellite site 104 selection is based at least in part on a comparison of study characteristics, such as the disease state or states involved, with a database containing information on rural physicians who are interested in participating. In some embodiments, such a database is compiled specifically for the purpose of assisting in satellite site 104 selection or identification.

In some embodiments of the invention, the integration organization selects or assists in the selection of the satellite sites based on alliances or relationships developed between the integration organization and professional medical organizations representing large numbers of physicians, such as, for example, the American Academy of Family Physicians. In some embodiments, such relationships are established prior to the study, such as during an earlier study, or for the purpose of later assisting in selection and identification of satellite sites.

At step 610, the participation of medical professionals at core and satellite sites is established, as necessary. Steps 606, 608, and 610 may be performed in different order than shown, or certain of the steps may be revisited. For example, in one embodiment, an initial decision is made regarding core sites and satellite sites that are desired to be utilized based on the results of mining of a database containing data regarding past clinical trial studies in accordance with the invention. However, before the initial decision can be made final, the participation of necessary parties at or associated with the sites must often be obtained. If such participation is not available, a modified decision may need to be made, affecting the identification and selection of the core sites and the satellite sites.

At step 612, technical equipment is deployed at the core sites and the satellite sites, as necessary. Step 612 is intended to indicate installation of the various hardware, software, Internet connection, and any other equipment necessary for the study, including all equipment necessary to provide the core sites and satellite sites with all necessary core site computers 222 and satellite site computers and other required equipment, according to the needs of the particular study as well as the usefulness of existing equipment at the sites.

At step 614, training is provided to medical professionals and any other individuals, such as, in some embodiments, subjects, as necessary at core sites and satellite sites. The training can include, in some embodiments, for example, training regarding recruitment of subjects, use of computers, computer equipment, specialized software, and electronic medical monitoring devices in accordance with the study.

At step 616, medical professionals at satellite sites assist in recruitment of appropriate patients of the medical professionals as subjects in the study. At step 618, subjects participate in the study from satellite sites and clinical trial data associated with the subjects is communicated to one or more core sites. At step 620, clinical trial study coordination is performed at the core sites. It is to be understood that, although step 620 is depicted after step 618, the activities of steps 618 and 620 can overlap in time. Finally, at step 622, clinical trial study analysis is performed at an interested party site in accordance with the study.

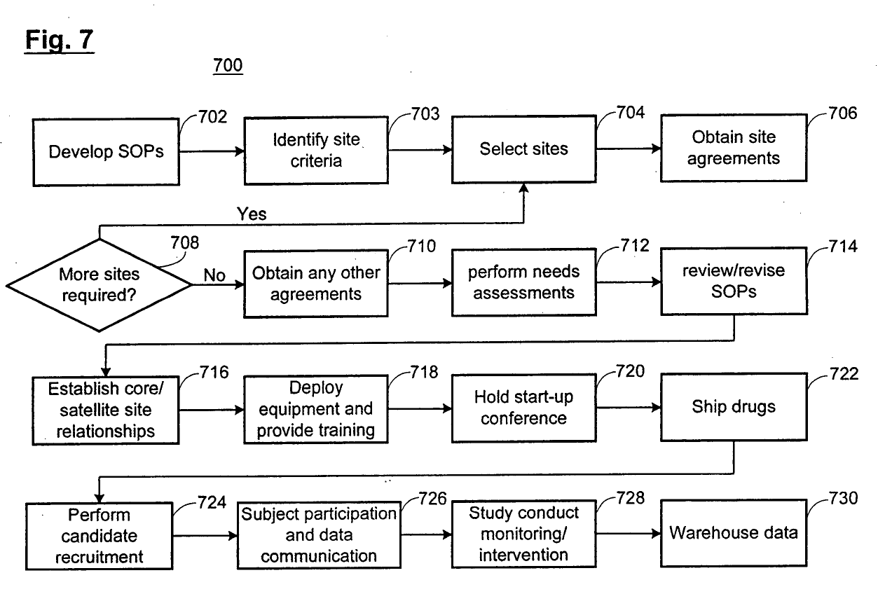

FIG. 7 is a flow diagram of one embodiment 700 of the method 600 for facilitating candidate and subject participation in a clinical trial study as depicted in FIG. 6. The method 700 is described assuming that an integration organization is involved in performing at least a portion of the method 700. It is to be understood, however, that, in different embodiments of the invention, the parties involved may be different, or their roles may be different.

At step 702, standard operating procedures (SOPs) relating to a specific clinical trial study are developed. For instance, SOPs can be developed to set acceptable standards and protocols regarding not only the medical or health care aspects of a study, but also can relate to such things as data input procedures, data transmission procedures, etc. SOPs can be developed for both core sites as well as satellite sites.

At step 703, site criteria are identified, which can include criteria pertaining to required or desired criteria for sites, which can include core sites, satellite sites, or both, to be utilized in conducting the study. The criteria can include physical criteria relating to sites' geographic locations or to the sites' physical plants, such as square footage of office space. The criteria can also include criteria relating to computers or other technical issues, including, for example, computer equipment and type or speed of Internet access. The criteria can further include criteria that are specific to the particular disease state or treatment involved in the study, including, for example, necessary medical equipment such as monitoring or treatment related equipment. For instance, in some cancer related studies, sites may need to have equipment necessary to administer chemotherapy treatment.

At step 704, desirable sites are selected based at least in part on the criteria established at step 702. Step 704 can include comparing characteristics of many possible sites, potentially including sites utilized in previous studies, with the established criteria to determine an optimal site network for the study. Additionally, step 704 can include physical surveys of possible sites to obtain or confirm site characteristics. In some embodiments, step 704 includes using data mining programs to obtain or determine relevant site data. Further, one or more computer algorithms and programs may be utilized to select or help select appropriate or optimal sites based at least in part on a comparison of site data with criteria data.

In some embodiments of the invention, site characteristic data may be obtained from data, including statistical data, stored from previous studies, which can include querying clinical trial databases and ancillary databases having data from one or more previous studies. Additionally, site characteristic data can be obtained from public databases that, for example, contain information about physicians' practices and patients, or physicians' prescription histories, such as the publicly available Integrated Medical Services database.

At step 706, site agreements to participate are obtained. Step 706 can include approaching individuals associated with desired sites, such as physicians or other medical professionals, and obtaining their agreement to participate in the study. In some embodiments, the agreement may include a written contract. In some embodiments of the invention in which an integration organization performs step 706, exclusive agreements or contracts may be obtained from participating sites or medical professionals. In one embodiment, exclusive agreements are sought or obtained from core sites or medical physicians at core sites, but non-exclusive agreement are sought or obtained from satellite sites or medical professionals at satellite sites. In some embodiments, physicians are offered compensation to participate in the study, which compensation may be dependent on their performance, such as based on the number of subjects who are patients of theirs who become subjects in the study, or who complete the study as subjects, or based in some way on a measurement of the amount of work the physician does in connection with the study.

At step 708, it is queried whether sufficient site participation has been obtained to provide sufficient sites to participate in the study. If no additional sites are needed, the method 700 proceeds to step 710. If additional sites are required, as can be the case, for example, if certain physicians decline to participate, or if certain sites were decided to be eliminated due to problems observed during site inspections, then the method 700 returns to step 704, at which additional potential sites are identified, of course considering those sites which have already been established as participating and those sites which are no longer considered possibilities. While steps 702-704 have been described as discrete steps, it is to be understood that the activities associated with each of the steps, as well as other steps of the method 700, may overlap, be performed multiple times, or be performed in a different order than depicted.

At step 710, agreements are obtained with parties other than those associated with the sites, as necessary. For example, step 710 can comprise the integration organization negotiating and obtaining agreements and contracts with a study sponsor or a contract research organization involved with the study, or resolving any legal issues which may have arisen.

At step 712, a needs assessment is performed upon participating sites. The needs assessment, which can include a site visit, is performed to determine what the site needs in order to effectively be utilized by participants in the study. The assessment takes into account the particular needs of the study and the existing computer systems, inventory and other resources of particular sites. The results of the assessment are utilized in eventually equipping and providing training or other services to sites as necessary for the study.

At step 714, SOP review and revision is performed, as necessary. Step 714 involves a revisiting of the SOPs initially established at step 702. The SOPs are reviewed in light of events and information obtained since step 702, to update, complete, or finalize SOPs. Step 714 can include comparing different SOPs and reviewing them together to ensure consistency, including revising certain SOPs if appropriate.

At step 716, which in some embodiments is performed by the integration organization, relationships are established between core sites and satellite sites, and between different core sites as necessary. Step 716 represents the bringing together of people and organizations as a precursor to and in order to facilitate and assure their coordinated interaction during the execution of the study.

At step 718, equipment deployment is performed and training is provided as appropriate at core and satellite sites. The needs assessment performed at step 712 is utilized at this step. Equipment and training provided will be based on all information acquired to date, including the needs assessment, agreements, and SOPs. Computers and computer related systems and equipment are deployed as needed, and high speed Internet connections are set up as appropriate, although obtaining service to provide actual access may be deferred as long as possible to avoid incurring unnecessary costs.

At step 720, a start up conference is held. In some embodiments, the start up conference is arranged and coordinated by the integration organization. The start up conference can take many forms, and can include a personal meeting between individuals from different core sites and satellite sites, individuals representing the sponsor, involved contract research organizations, or other parties having an interest or role in the study. In one embodiment, the conference can be a video and audio conference held over a computer network between geographically dispersed parties each utilizing their local computers.

At step 722, drugs are shipped to sites in accordance with the anticipated study needs. Method 700 assumes a clinical trial drug study, but other types of clinical trial studies are possible in other embodiments of the invention, such as, for example, studies of subjects' responses to particular new physical therapy, or subjects' responses to a new type of prosthetic device.

At step 724, candidate recruitment is performed, including medical professionals at satellite sites assisting in recruitment of appropriate patients of theirs as subjects in the study. In some embodiments of the invention, medical professionals at core sites also assist in recruitment activities, which can include recruitment of patients of theirs as subjects.

Step 724 can involve, for example, participating physicians at satellite sites informing appropriate patients of theirs of the study and suggesting that they consider attempting to participate as subjects. Step 724 also includes any necessary screening of candidates to make sure they are sufficiently qualified to participate in the study, such as by being the appropriate age, having the appropriate medical condition, etc.

In some embodiments, step 724 includes obtaining data from candidates, such as candidates who indicate that they may wish to participate in future studies, and storing the data in an ancillary database, to be utilized in future study planning and recruitment activities. Also, step 724 can include utilizing information of this type from previous studies in order to identify, target, or approach potential candidates for the study. Step 724 also includes inviting qualified candidates to participate as subjects, and obtaining any necessary agreements or consents, including written agreements or consents, from candidates who agree to participate as subjects. Step 724 is also intended to include any recruitment which may need to be performed at a later time to replace any subjects who unexpectedly decide to not participate or who drop out but can be replaced. As such, step 724 can be revisited at different stages in the method 700.

At step 726, subjects participate in the study and data is obtained and communicated in accordance with the invention. Step 726 includes communicating clinical trial data from satellite sites to core sites in accordance with the study. Step 726 also includes, in some embodiments of the invention, monitoring by the integration organization of study conduct and execution.

At step 728, study conduct and execution is monitored and assistance or intervention is provided as necessary. In some embodiments, step 728 is performed at least in part by the integration organization. The monitoring can be for purposes including ensuring that study conduct and execution at sites complies with SOP and any other applicable procedures and protocols. Assistance can be provided in terms of, for example, providing additional equipment or training as the need arises and providing computer related support. Obviously, although step 728 is depicted as following step 726, the steps can overlap each other.

At step 730, warehousing of data is performed at or after completion of the study. Step 730 assumes that the study results have been finally obtained and recorded, and includes any and all appropriate storage and organization of data, such as in a clinical trial database and ancillary databases, for purposes which may include utilization of the warehoused data in future study planning or execution. Step 730 can also include preparing an information matrix representative of all of the collected data for the study.

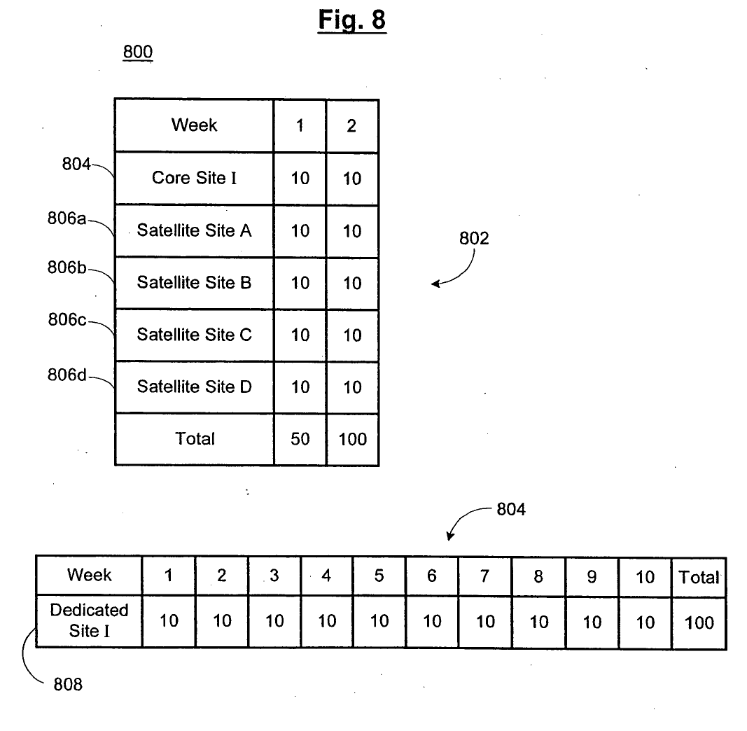

FIG. 8 is a chart 800 depicting improved recruitment of subjects according to one embodiment of the invention. FIG. 8 supposes, for simplicity, a study for which 100 subjects are required, and assumes a uniform rate of 10 subjects recruited per week of recruitment activities per site. Box 802 demonstrates that, with the use of a network according to one embodiment of the invention of a single core site, specifically, core site I, and four satellite sites 806_{a-d}, specifically, satellite sites A through D, the full 100 subjects are recruited in two weeks. By contrast, box 804 shows that, with only a single dedicated site 818, specifically, dedicated site I, it takes five times as long, specifically, ten weeks, to recruit the needed 100 subjects. Moreover, the improved results depicted in Box 802 do not take into account improved recruitment rates, and hence shorter required time for recruitment, as a result of the assistance of medical professionals at the satellite sites 806_{a-d} in recruitment of subjects.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A system for facilitating candidate and subject participation in a clinical trial study, the system comprising:
one or more interested party sites at which collected clinical trial data is analyzed in accordance with the study, each of the interested party sites having one or more interested party site computers, and the collected clinical trial data being communicated to the interested party site computers over a network;
a plurality of core sites at which coordination of the clinical trial study is performed, each of the core sites having one or more core site computers; and
a plurality of satellite sites at which one or more medical professionals participating in the study assist in recruitment of one or more pre-existing patients of the medical professionals as subjects in the study from whom a first set of clinical trial data of the collected clinical trial data is collected, each of the satellite sites having one or more satellite site computers connected through the network to at least one of the core site computers, wherein the first set of clinical trial data is communicated from each of the satellite sites by one or more of the satellite site computers over the network to one or more of the core site computers.

2. The system of claim 1, wherein the medical professionals assist in identification of candidates.

3. The system of claim 1, wherein a second set of clinical trial data is collected from one or more subjects at one or more of the core sites.

4. The system of claim 1, wherein the first set of clinical trial data is collected at the satellite sites and input into the satellite site computers.

5. The system of claim 1, wherein the network comprises the Internet.

6. The system of claim 1, comprising means for coordinating and managing the study from the core sites, including means for monitoring study related activities occurring at the satellite sites.

7. The system of claim 1, comprising a clinical trial database connected to the network, and wherein all clinical trial data for the study is stored in the clinical trial database.

8. The system of claim 1, comprising means for selecting appropriate participating medical professionals for the study including means for querying a database containing information about the practices of the medical professionals, based on characteristics of the study.

9. The system of claim 1, comprising means for targeting patients as candidates including means for querying a database containing information about medical histories of the patients, based on characteristics of the study.

10. The system of claim 1, comprising a historical database storing statistical data associated with the clinical trial study in one or more databases, and comprising means for utilizing the historical database in planning one or more future clinical trial studies.

11. The system of claim 10, wherein the means for utilizing the historical database comprises means for using statistical data in at least one of selecting one or more appropriate satellite sites for a future clinical trial study, selecting one or more appropriate core sites for a future clinical trial study, and selecting one or more appropriate medical professionals to participate in a future clinical trial study.

12. The system of claim 1, wherein the network comprises the Internet, and comprising means for connecting the satellite site computers and the core site computers to the Internet by high speed Internet connections of at least 100,000 bits per second, and comprising means for enabling subjects to communicate from the satellite sites with investigators at the core sites by communication between the satellite site computers and the core site computers over the Internet in real time or almost real time and comprising at least one of interactive streaming audio and interactive streaming video media presentations presented through monitors of the satellite site computers and the core site computers.

13. The system of claim 1, wherein the medical professionals comprise physicians, and wherein the physicians utilize the physicians' medical records to identify a first set of patients of the physicians who seem to be appropriately qualified participate as subjects in the study.

14. The system of claim 13, wherein the physicians recruit patients of the first set such that the patients of the first set enroll as subjects in the study.

15. The system of claim 14, wherein clinical trial data collected from the patients of the first set at the satellite sites is communicated from the satellite site computers at the satellite sites over the Internet to the core site computers at the core sites.

16. The system of claim 1, wherein each of the core sites is associated with a set of one or more of the satellite sites, and comprising means for, at each of the core sites, performing coordination of clinical trial study related activities occurring at the associated set of satellite sites.

17. The system of claim 16, comprising means for, at each of the core sites, tracking clinical trial study related activities occurring at the associated set of satellite sites to monitor compliance with protocol associated with the clinical trial study.

18. The system of claim 1, comprising means for allowing pier to pier communication between core site computers of the core site computers and satellite site computers of the satellite site computers.

19. A method for facilitating candidate and subject participation in a clinical trial study, the method comprising:
a plurality of medical professionals at a plurality of satellite sites assisting in recruitment of one or more pre-existing patients of the medical professionals as subjects in the study;
one or more of the subjects in the study participating from the satellite sites, comprising collecting a first set of clinical trial data from the subjects and communicating the first set of clinical trial data over a network from one or more satellite site computers at the satellite sites to one or more core site computers at a plurality of core sites;
performing clinical trial study coordination at the core sites; and
analyzing the first set of clinical trial in accordance with the study at one or more interested party sites, the first set of clinical trial data being communicated to one or more interested party site computers at the one or more interested party sites over the network.

20. The method of claim 19, comprising the medical professionals assisting in identification of candidates.

21. The method of claim 19, wherein a second set of clinical trial data is collected from one or more subjects at one or more of the core sites.

22. The method of claim 19, wherein the first set of clinical trial data is collected at the satellite sites and input into the satellite site computers.

23. The method of claim 19, wherein the communicating over the network comprises communicating over the Internet.

24. The method of claim 19, comprising performing management of the clinical trial study at the core sites, and comprising monitoring study related activities occurring at the satellite sites.

25. The method of claim 19, comprising storing all clinical trial data for the study in a clinical trial database connected to the network.

26. The method of claim 19, wherein appropriate participating medical professionals for the study are identified at least in part by querying of a database containing information about the practices of the medical professionals based on characteristics of the study.

27. The method of claim 19, wherein the patients are targeted as candidates at least in part by querying of a database containing information about medical histories of the patients, based on characteristics of the study.

28. The method of claim 19, comprising storing statistical data associated with the clinical trial study in one or more databases, and comprising utilizing the statistical data in planning one or more future studies.

29. The method of claim 28, wherein the statistical data is utilized in at least one of selecting one or more appropriate satellite sites for a future clinical trial study, selecting one or more appropriate core sites for a future clinical trial study, and selecting one or more appropriate medical professionals to participate in a future clinical trial study.

30. The method of claim 19, wherein the network comprises the Internet, and wherein the satellite site computers and the core site computers are connected to the Internet by high speed Internet connections of at least 100,000 bits per second, and wherein the subjects communicate from the satellite sites with investigators at the core sites by communication between the satellite site computers and the core site computers, and wherein the communication is in real time or almost real time and comprises at least one of interactive streaming audio and interactive streaming video media presentations presented through monitors of the satellite site computers and the core site computers.

31. The method of claim 19, wherein the medical professionals comprise physicians, and comprising the physicians utilizing the physicians' medical records to identify a first set of patients of the physicians who seem to be appropriately qualified participate as subjects in the study.

32. The method of claim 31, comprising the physicians recruiting patients of the first set such that the patients of the first set enroll as subjects in the study.

33. The method of claim 32, comprising communicating clinical trial data, collected from the patients of the first set at the satellite sites, from the satellite site computers at the satellite sites over the Internet to the core site computers at the core sites.

34. The method of claim 19, wherein each of the core sites is associated with a set of one or more of the satellite sites, and comprising performing, at each of the core sites, coordination of clinical trial related activities occurring at the associated set of satellite sites.

35. The method of claim 34, comprising, at each of the core sites, tracking clinical trial study related activities occurring at the associated set of satellite sites to monitor compliance with protocol associated with the clinical trial study.

36. The method of claim 19, comprising pier to pier communicating between core site computers of the core site computers and satellite site computers of the satellite site computers.

37. A computer usable medium storing program code which, when executed on a computerized device, causes the computerized device to execute a method for facilitating candidate and subject participation in a clinical trial study, the method comprising:
a plurality of medical professionals at a plurality of satellite sites assisting in recruitment of one or more pre-existing patients of the medical professionals as subjects in the study;
one or more of the subjects in the study participating from the satellite sites, comprising collecting a first set of clinical trial data from the subjects and communicating the first set of clinical trial data over a network from one or more satellite site computers at the satellite sites to one or more core site computers at a plurality of core sites;
performing clinical trial study coordination at the core sites; and
analyzing the first set of clinical trial in accordance with the study at one or more interested party sites, the first set of clinical trial data being communicated to one or more interested party site computers at the one or more interested party sites over the network.
